(19) United States
(12) Patent Application Publication
(10) Pub. No.: US 2016/0336756 A1
(43) Pub. Date: Nov. 17, 2016

(54) VARIABLE AC LOAD

(71) Applicant: QUALCOMM Incorporated, San Diego, CA (US)

(72) Inventors: Joshua Archelaus Holzworth, San Diego, CA (US); Linda Stacey Irish, San Diego, CA (US); Cody Burton Wheeland, San Diego, CA (US)

(21) Appl. No.: 14/712,011

(22) Filed: May 14, 2015

(51) Int. Cl. H02J 5/00

(52) U.S. Cl. CPC H02J 5/005

(57) ABSTRACT

A variable AC load includes a three element structure, wherein a relative position of a first element, a second element, and a third element is configured to provide continually adjustable inductive reactance and resistance.

### FIELD

The present disclosure relates generally to wireless power. More specifically, the disclosure is directed to a variable alternating current (AC) load.

### DESCRIPTION OF THE RELATED ART

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections that require cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices may overcome some of the deficiencies of wired charging solutions. As such, wireless charging systems and methods that efficiently and safely transfer power for charging rechargeable electronic devices are desirable. Moreover, it is desirable to have the ability to test such wireless charging systems to ensure that they are capable of providing the desired power.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a variable AC load having a conductive element, an inductive element, and a resistive element, wherein a relative position of the conductive element with respect to the inductive element, and a relative position of the resistive element with respect to the inductive element, provides continually and simultaneously adjustable inductive reactance and resistance.

Another aspect of the disclosure provides a variable AC load having a three element structure, wherein a relative position of a first element, a second element, and a third element is configured to provide continually adjustable inductive reactance and resistance.

Another aspect of the disclosure provides a device for generating a variable AC load having means for adjusting an inductive reactance of the variable AC load, means for adjusting a resistance of the variable AC load and means for simultaneously adjusting inductive reactance and resistance of the variable AC load.

Another aspect of the disclosure provides a method for generating a variable AC load including locating a conductive element relative to an inductive element to adjust an inductive reactance, locating a resistive element relative to the inductive element to adjust a resistance and simultaneously adjusting the inductive reactance and the resistance.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram of an exemplary wireless power transfer system, in accordance with exemplary embodiments of the invention.

FIG. 2 is a functional block diagram of exemplary components that may be used in the wireless power transfer system of FIG. 1, in accordance with various exemplary embodiments of the invention.

FIG. 3 is a schematic diagram of a portion of transmit circuitry or receive circuitry of FIG. 2 including a transmit or receive antenna, in accordance with exemplary embodiments of the invention.

FIG. 4 is a functional block diagram of a transmitter that may be used in the wireless power transfer system of FIG. 1, in accordance with exemplary embodiments of the invention.

FIG. 5 is a functional block diagram of a receiver that may be used in the wireless power transfer system of FIG. 1, in accordance with exemplary embodiments of the invention.

FIG. 6 is a schematic diagram of a portion of transmit circuitry that may be used in the transmit circuitry of FIG. 4.

FIG. 7A is a simplified schematic diagram illustrating an embodiment of a variable AC load.

FIG. 7B is a simplified schematic diagram illustrating an alternative embodiment of a variable AC load.

FIGS. 8A and 8B show an exemplary embodiment of three elements that comprise a variable AC load.

FIGS. 9A and 9B show an alternative exemplary embodiment of three elements that comprise a variable AC load.

FIG. 10 shows a graphical depiction of the operational ranges of the resistance and inductive reactance of the variable AC load of FIGS. 8A and 8B and the variable AC load of FIGS. 9A and 9B.

FIG. 11 is a flowchart illustrating an exemplary embodiment of a method for varying an AC load.

FIG. 12 is a functional block diagram of an apparatus for varying an AC load.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving antenna” to achieve power transfer.

It is desirable to have the ability to test wireless charging systems to be sure that they are capable of providing the desired power. For example, in a system where a wireless power transmitter may simultaneously couple power to multiple devices, the different combinations and types of devices receiving power may present a wide range of complex (e.g., resistive and reactive) impedances to the circuitry driving the transmit coil. In this case, it may be desirable to test the transmit circuitry over a large range of complex impedances to determine whether the system is capable of providing the desired power over this range. A variable impedance is generally used to test a wireless power transmitting unit. The variable impedance can be used to simulate the effect of changes and variations in the transfer of power through free space. One way of creating a variable impedance is to implement fixed inductors along with banks of switchable resistors and switchable capacitors to change the impedance presented to a wireless power transmitting unit. Unfortunately, using fixed inductors along with banks of switchable resistors and switchable capacitors limits the resolution of the impedance variation and introduces transients between power set points. Exemplary embodiments of the variable AC load overcome the above-mentioned drawbacks, particularly for testing a wireless power transmitting unit.

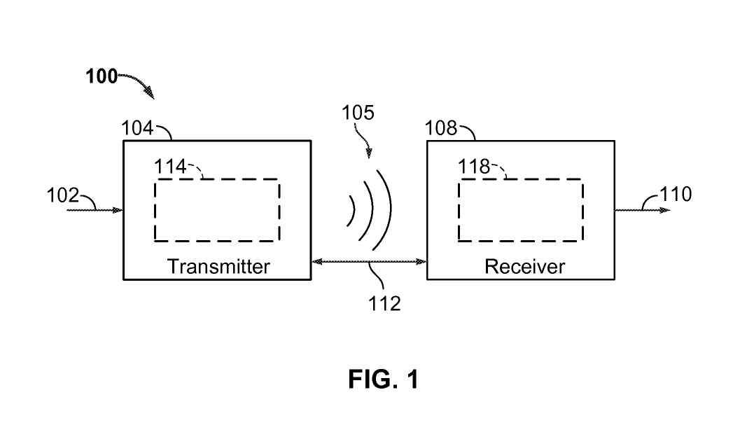

FIG. 1 is a functional block diagram of an exemplary wireless power transfer system 100, in accordance with exemplary embodiments of the invention. Input power 102 may be provided to a transmitter 104 from a power source (not shown) for generating a field 105 (e.g., magnetic or species of electromagnetic) for providing energy transfer. A receiver 108 may couple to the field 105 and generate output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship. When the resonant frequency of receiver 108 and the resonant frequency of transmitter 104 are substantially the same or very close, transmission losses between the transmitter 104 and the receiver 108 are reduced. As such, wireless power transfer may be provided over larger distances in contrast to purely inductive solutions that may require large coils to be very close (e.g., millimeters). Resonant inductive coupling techniques may thus allow for improved efficiency and power transfer over various distances and with a variety of inductive coil configurations.

The receiver 108 may receive power when the receiver 108 is located in an energy field 105 produced by the transmitter 104. The field 105 corresponds to a region where energy output by the transmitter 104 may be captured by a receiver 108. In some cases, the field 105 may correspond to the “near-field” of the transmitter 104 as will be further described below. The transmitter 104 may include a transmit antenna 114 (that may also be referred to herein as a coil) for outputting an energy transmission. The receiver 108 further includes a receive antenna 118 (that may also be referred to herein as a coil) for receiving or capturing energy from the energy transmission. The near-field may correspond to a region in which there are strong reactive fields resulting from the currents and charges in the transmit antenna 114 that minimally radiate power away from the transmit antenna 114. In some cases the near-field may correspond to a region that is within about one wavelength (or a fraction thereof) of the transmit antenna 114. When positioned within the field 105, a “coupling mode” may be developed between the transmit antenna 114 and the receive antenna 118. The area around the transmit and receive antennas 114 and 118 where this coupling may occur may be referred to as a coupling-mode region.

In accordance with the above therefore, in accordance with more particular embodiments, the transmitter 104 may be configured to output a time varying magnetic field 105 with a frequency corresponding to the resonant frequency of the transmit antenna 114. When the receiver is within the field 105, the time varying magnetic field 105 may induce a voltage in the receive antenna 118 that causes an electrical current to flow through the receive antenna 118. As described above, if the receive antenna 118 is configured to be resonant at the frequency of the transmit antenna 114, energy may be efficiently transferred. The AC signal induced in the receive antenna 118 may be rectified as described above to produce a DC signal that may be provided to charge or to power a load.

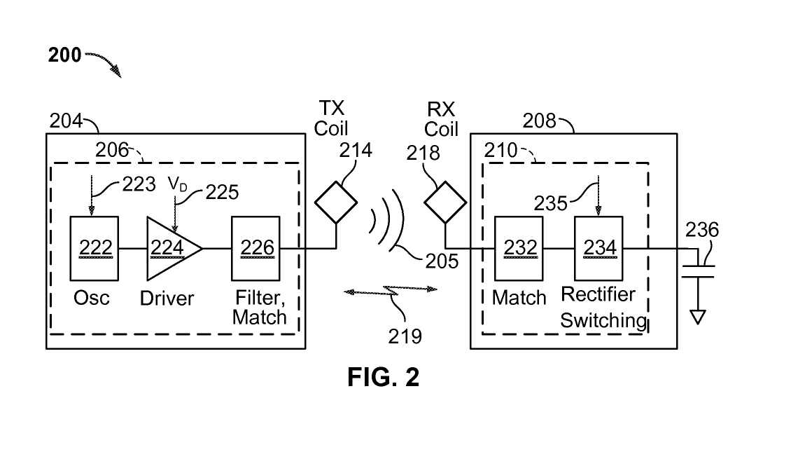

FIG. 2 is a functional block diagram of exemplary components that may be used in the wireless power transfer system 100 of FIG. 1, in accordance with various exemplary embodiments of the invention. The transmitter 204 may include transmit circuitry 206 that may include an oscillator 222, a driver circuit 224, and a filter and matching circuit 226. The oscillator 222 may be configured to generate a signal at a desired frequency, such as 468.75 KHz, 6.78 MHz or 13.56 MHz, that may be adjusted in response to a frequency control signal 223. The oscillator signal may be provided to a driver circuit 224 configured to drive the transmit antenna 214 at, for example, a resonant frequency of the transmit antenna 214. The driver circuit 224 may be a switching amplifier configured to receive a square wave from the oscillator 222 and output a sine wave. For example, the driver circuit 224 may be a class E amplifier. A filter and matching circuit 226 may be also included to filter out harmonics or other unwanted frequencies and match the impedance of the transmitter 204 to the transmit antenna 214. As a result of driving the transmit antenna 214, the transmitter 204 may wirelessly output power at a level sufficient for charging or powering an electronic device. As one example, the power provided may be for example on the order of 300 milliWatts to 5 Watts or 5 Watts to 40 Watts to power or charge different devices with different power requirements. Higher or lower power levels may also be provided.

The receiver 208 may include receive circuitry 210 that may include a matching circuit 232 and a rectifier and switching circuit 234 to generate a DC power output from an AC power input to charge a battery 236 as shown in FIG. 2 or to power a device (not shown) coupled to the receiver 108. The matching circuit 232 may be included to match the impedance of the receive circuitry 210 to the receive antenna 218. The receiver 208 and transmitter 204 may additionally communicate on a separate communication channel 219 (e.g., Bluetooth, zigbee, cellular, etc). The receiver 208 and transmitter 204 may alternatively communicate via in-band signaling using characteristics of the wireless field 205.

The receiver 208 may initially have a selectively disablable associated load (e.g., battery 236), and may be configured to determine whether an amount of power transmitted by transmitter 204 and received by receiver 208 is appropriate for charging a battery 236. Further, receiver 208 may be configured to enable a load (e.g., battery 236) upon determining that the amount of power is appropriate.

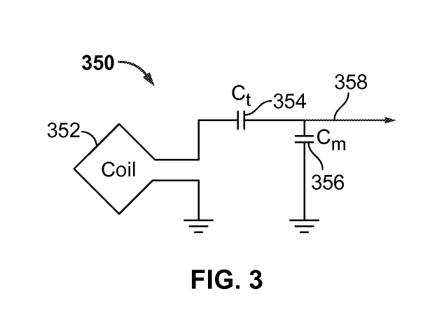

FIG. 3 is a schematic diagram of a portion of transmit circuitry 206 or receive circuitry 210 of FIG. 2 including a transmit or receive antenna 352, in accordance with exemplary embodiments of the invention. As illustrated in FIG. 3, transmit or receive circuitry 350 used in exemplary embodiments including those described below may include an antenna 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna 352 may also be referred to as a coil of a type that is configured to wirelessly output or receive power. As used herein, an antenna 352 is an example of a “power transfer component” of a type that is configured to wirelessly output and/or receive power. The antenna 352 may be configured to include an air core or a physical core such as a ferrite core (not shown).

The antenna 352 may form a portion of a resonant circuit configured to resonate at a resonant frequency. The resonant frequency of the loop or magnetic antenna 352 is based on the inductance and capacitance. Inductance may be simply the inductance created by the antenna 352, whereas, capacitance may be added to create a resonant structure (e.g., a capacitor may be electrically connected to the antenna 352 in series or in parallel) at a desired resonant frequency. As a non-limiting example, capacitor 354 and capacitor 356 may be added to the transmit or receive circuitry 350 to create a resonant circuit that resonates at a desired frequency of operation. For larger diameter antennas, the size of capacitance needed to sustain resonance may decrease as the diameter or inductance of the loop increases. As the diameter of the antenna increases, the efficient energy transfer area of the near-field may increase. Other resonant circuits formed using other components are also possible. As another non-limiting example, a capacitor (not shown) may be placed in parallel between the two terminals of the antenna 350. For transmit antennas, a signal 358 with a frequency that substantially corresponds to the resonant frequency of the antenna 352 may be an input to the antenna 352. For receive antennas, the signal 358 may be the output that may be rectified and used to power or charge a load.

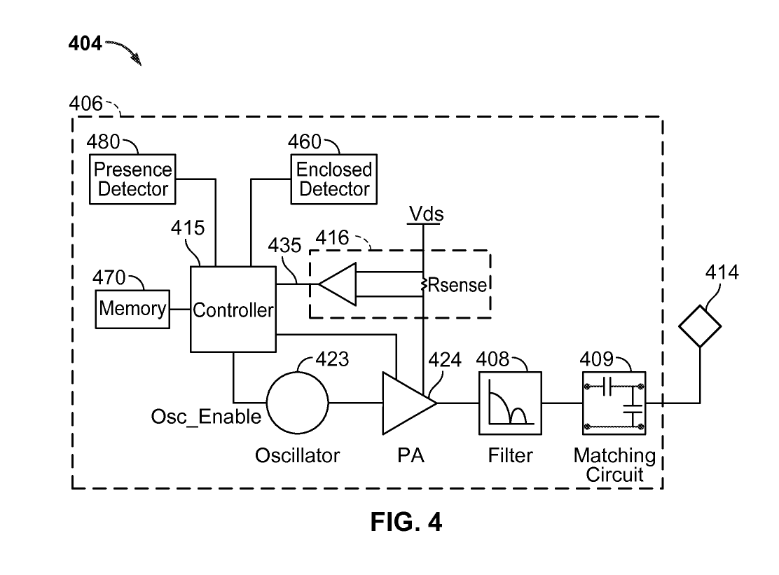

FIG. 4 is a functional block diagram of a transmitter 404 that may be used in the wireless power transfer system of FIG. 1, in accordance with exemplary embodiments of the invention. The transmitter 404 may include transmit circuitry 406 and a transmit antenna 414. The transmit antenna 414 may be the antenna 352 as shown in FIG. 3. The transmit antenna 414 may be configured as the transmit antenna 214 as described above in reference to FIG. 2. In some implementations, the transmit antenna 414 may be a coil (e.g., an induction coil). In some implementations, the transmit antenna 414 may be associated with a larger structure, such as a pad, table, mat, lamp, or other stationary configuration. Transmit circuitry 406 may provide power to the transmit antenna 414 by providing an oscillating signal resulting in generation of energy (e.g., magnetic flux) about the transmit antenna 414. Transmitter 404 may operate at any suitable frequency. By way of example, transmitter 404 may operate at the 6.78 MHz ISM band.

Transmit circuitry 406 may include a fixed impedance matching circuit 409 for matching the impedance of the transmit circuitry 406 (e.g., 50 ohms) to the transmit antenna 414 and a low pass filter (LPF) 408 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that may be varied based on measurable transmit metrics, such as output power to the antenna 414 or DC current drawn by the driver circuit 424. Transmit circuitry 406 further includes a driver circuit 424 configured to drive a signal as determined by an oscillator 423. The transmit circuitry 406 may be comprised of discrete devices or circuits, or alternately, may be comprised of an integrated assembly.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as a processor. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit antenna 414. By way of example, a load sensing circuit 416 monitors the current flowing to the driver circuit 424, that may be affected by the presence or absence of active receivers in the vicinity of the field generated by transmit antenna 414 as will be further described below. Detection of changes to the loading on the driver circuit 424 are monitored by controller 415 for use in determining whether to enable the oscillator 423 for transmitting energy and to communicate with an active receiver. As described more fully below, a current measured at the driver circuit 424 may be used to determine whether an invalid device is positioned within a wireless power transfer region of the transmitter 404.

The transmit antenna 414 may be implemented with a Litz wire or as an antenna strip with the thickness, width and metal type selected to keep resistive losses low.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert conventional AC power present in a building, a DC-DC converter (not shown) to convert a conventional DC power source to a voltage suitable for the transmitter 404, or directly from a conventional DC power source (not shown).

As a non-limiting example, the presence detector 480 may be a motion detector utilized to sense the initial presence of a device to be charged that is inserted into the coverage area of the transmitter 404. After detection, the transmitter 404 may be turned on and the RF power received by the device may be used to toggle a switch on the Rx device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some exemplary embodiments, there may be regulations limiting the amount of power that a transmit antenna 414 may transmit at a specific frequency. In some cases, these regulations are meant to protect humans from electromagnetic radiation. However, there may be environments where a transmit antenna 414 is placed in areas not occupied by humans, or occupied infrequently by humans, such as, for example, garages, factory floors, shops, and the like. If these environments are free from humans, it may be permissible to increase the power output of the transmit antenna 414 above the normal power restrictions regulations. In other words, the controller 415 may adjust the power output of the transmit antenna 414 to a regulatory level or lower in response to human presence and adjust the power output of the transmit antenna 414 to a level above the regulatory level when a human is outside a regulatory distance from the electromagnetic field of the transmit antenna 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 404 does not remain on indefinitely may be used. In this case, the transmitter 404 may be programmed to shut off after a user-determined amount of time. This feature prevents the transmitter 404, notably the driver circuit 424, from running long after the wireless devices in its perimeter are fully charged. This event may be due to the failure of the circuit to detect the signal sent from either the repeater or the receive antenna 218 that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

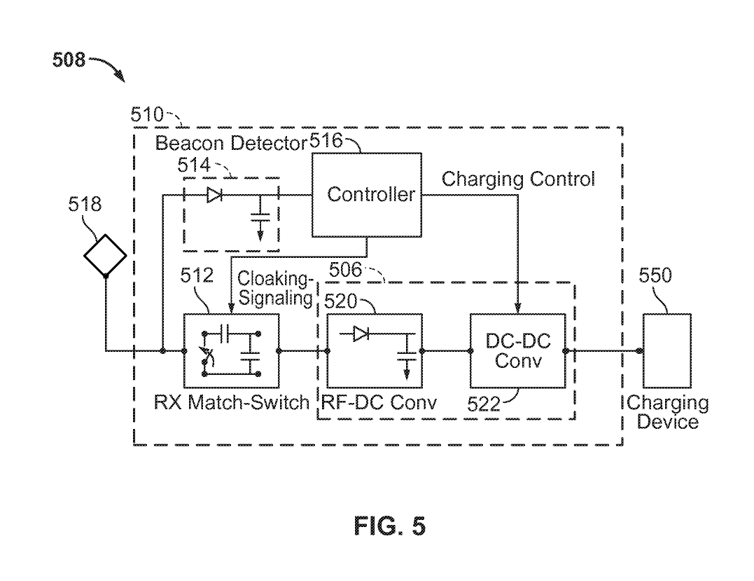

FIG. 5 is a functional block diagram of a receiver 508 that may be used in the wireless power transfer system of FIG. 1, in accordance with exemplary embodiments of the invention. The receiver 508 includes receive circuitry 510 that may include a receive antenna 518. Receiver 508 further couples to device 550 for providing received power thereto. It should be noted that receiver 508 is illustrated as being external to device 550 but may be integrated into device 550. Energy may be propagated wirelessly to receive antenna 518 and then coupled through the rest of the receive circuitry 510 to device 550. By way of example, the charging device may include devices such as mobile phones, portable music players, laptop computers, tablet computers, computer peripheral devices, communication devices (e.g., Bluetooth devices), digital cameras, hearing aids (and other medical devices), wearable devices, and the like.

Receive antenna 518 may be tuned to resonate at the same frequency, or within a specified range of frequencies, as transmit antenna 414 (FIG. 4). Receive antenna 518 may be similarly dimensioned with transmit antenna 414 or may be differently sized based upon the dimensions of the associated device 550. By way of example, device 550 may be a portable electronic device having diametric or length dimension smaller than the diameter or length of transmit antenna 414. In such an example, receive antenna 518 may be implemented as a multi-turn coil in order to reduce the capacitance value of a tuning capacitor (not shown) and increase the receive coil's impedance. By way of example, receive antenna 518 may be placed around the substantial circumference of device 550 in order to maximize the antenna diameter and reduce the number of loop turns (i.e., windings) of the receive antenna 518 and the inter-winding capacitance.

Receive circuitry 510 may provide an impedance match to the receive antenna 518. Receive circuitry 510 includes power conversion circuitry 506 for converting a received RF energy source into charging power for use by the device 550. Power conversion circuitry 506 includes an RF-to-DC converter 520 and may also include a DC-to-DC converter 522. RF-to-DC converter 520 rectifies the RF energy signal received at receive antenna 518 into a non-alternating power with an output voltage. The DC-to-DC converter 522 (or other power regulator) converts the rectified RF energy signal into an energy potential (e.g., voltage) that is compatible with device 550 with an output voltage and output current. Various RF-to-DC converters are contemplated, including partial and full rectifiers, regulators, bridges, doublers, as well as linear and switching converters.

Receive circuitry 510 may further include RX matching and switching circuitry 512 for connecting receive antenna 518 to the power conversion circuitry 506 or alternatively for disconnecting the power conversion circuitry 506. Disconnecting receive antenna 518 from power conversion circuitry 506 not only suspends charging of device 550, but also changes the “load” as “seen” by the transmitter 404 (FIG. 2).

When multiple receivers 508 are present in a transmitter's near-field, it may be desirable to time-multiplex the loading and unloading of one or more receivers to enable other receivers to more efficiently couple to the transmitter. A receiver 508 may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 may provide a communication mechanism from receiver 508 to transmitter 404. Additionally, a protocol may be associated with the switching that enables the sending of a message from receiver 508 to transmitter 404. By way of example, a switching speed may be on the order of 100 μsec.

In an exemplary embodiment, communication between the transmitter 404 and the receiver 508 may take place either via an “out-of-band” separate communication channel/antenna or via “in-band” communication that may occur via modulation of the field used for power transfer.

Receive circuitry 510 may further include signaling detector and beacon circuitry 514 used to identify received energy fluctuations that may correspond to informational signaling from the transmitter to the receiver. Furthermore, signaling and beacon circuitry 514 may also be used to detect the transmission of a reduced RF signal energy (i.e., a beacon signal) and to rectify the reduced RF signal energy into a nominal power for awakening either un-powered or power-depleted circuits within receive circuitry 510 in order to configure receive circuitry 510 for wireless charging.

Receive circuitry 510 further includes controller 516 for coordinating the processes of receiver 508 described herein including the control of switching circuitry 512 described herein. It is noted that the controller 516 may also be referred to herein as a processor. Cloaking of receiver 508 may also occur upon the occurrence of other events including detection of an external wired charging source (e.g., wall/USB power) providing charging power to device 550. Controller 516, in addition to controlling the cloaking of the receiver, may also monitor beacon circuitry 514 to determine a beacon state and extract messages sent from the transmitter 404. Controller 516 may also adjust the DC-to-DC converter 522 for improved performance.

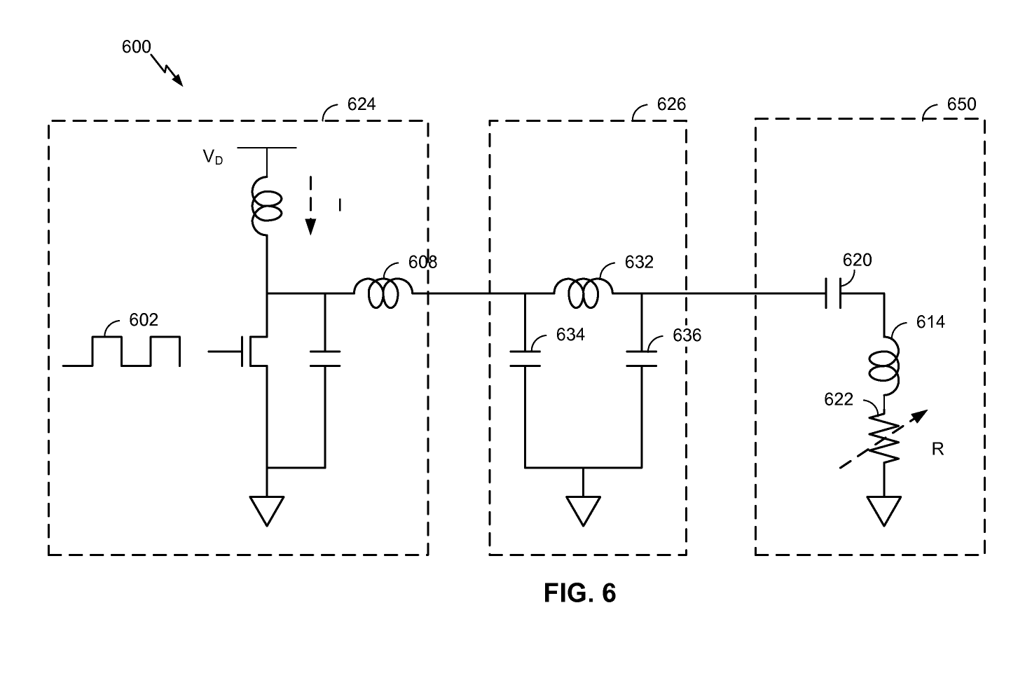

FIG. 6 is a schematic diagram of a portion of transmit circuitry 600 that may be used in the transmit circuitry 406 of FIG. 4. The transmit circuitry 600 may include a driver circuit 624 as described above in FIG. 4. As described above, the driver circuit 624 may be a switching amplifier that may be configured to receive a square wave and output a sine wave to be provided to the transmit circuit 650. In some cases the driver circuit 624 may be referred to as an amplifier circuit. The driver circuit 624 is shown as a class E amplifier, however, any suitable driver circuit 624 may be used in accordance with embodiments of the invention. The driver circuit 624 may be driven by an input signal 602 from an oscillator 423 as shown in FIG. 4. The driver circuit 624 may also be provided with a drive voltage V_{D} that is configured to control the maximum power that may be delivered through a transmit circuit 650. To eliminate or reduce harmonics, the transmit circuitry 600 may include a filter circuit 626. The filter circuit 626 may be a three pole (capacitor 634, inductor 632, and capacitor 636) low pass filter circuit 626.

The signal output by the filter circuit 626 may be provided to a transmit circuit 650 comprising an antenna 614. The transmit circuit 650 may include a series resonant circuit having a capacitance 620 and inductance (e.g., that may be due to the inductance or capacitance of the antenna or to an additional capacitor component) that may resonate at a frequency of the filtered signal provided by the driver circuit 624. The load of the transmit circuit 650 may be represented by the variable resistor 622. The load may be a function of a wireless power receiver 508 that is positioned to receive power from the transmit circuit 650.

In an exemplary embodiment, it is desirable to have the ability to test the transmitter 404 to ensure that it is capable of providing the desired power output over a range of operating conditions. For example, in a system where the transmitter 404 is configured to simultaneously couple power to multiple receiver devices, the different combinations and types of receive devices receiving power may present a wide range of complex (e.g., resistive and reactive) impedances to the circuitry (e.g., driver circuit 624 of FIG. 6) driving the transmit antenna 614 (FIG. 6). In this case, it may be desirable to test the transmit circuitry over a large range of complex impedances to determine whether the system is capable of providing the desired power over this range. In order to properly test the transmitter 404, it is desirable to have the ability to simulate a load (i.e., a power receiving unit) placed in the vicinity of the antenna 414 (FIG. 4). In an exemplary embodiment, a variable AC load can be implemented in or as part of a piece of test equipment that is coupled to the output of the transmit circuitry 406 (FIG. 4) in place of or in addition to the transmit antenna 414 so as to simulate the variable loading created by the presence of a receive antenna. The variable AC load may also be implemented as a separate element independent of the transmit antenna 414 and/or any test equipment.

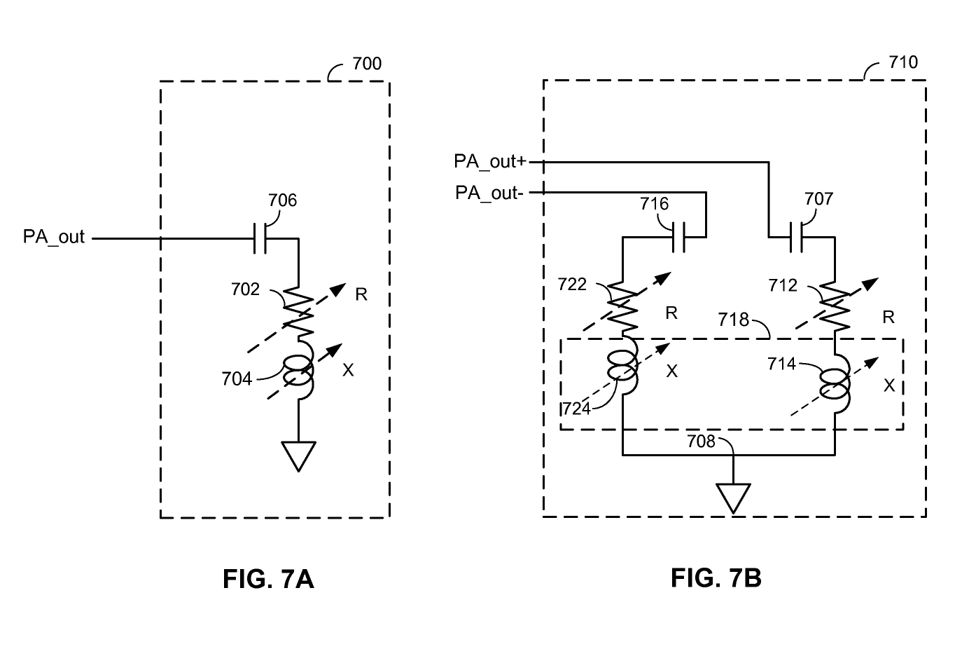

FIG. 7A is a simplified schematic diagram illustrating an embodiment of a variable AC load. The variable AC load 700 illustrates a single-ended implementation comprising an adjustable resistance 702 and an adjustable inductive reactance (X) 704. A capacitance 706 represents the characteristic capacitance of the variable AC load 700, and is not necessarily adjustable. The capacitance 706 may be a discrete element that is part of the variable AC load 700, or the capacitance 706 may be a separate element. In an exemplary embodiment, the operational range of the variable AC load 700 encompasses the impedance range of the transmit antenna (414, 614) (or presented by the transmit antenna 414, 614) that operates with the driver circuit (424, 624) in the transmit circuitry 406 (FIG. 4). Adjusting the resistance and the inductive reactance (i.e., reactance shifting) of the variable AC load 700 maps the impedance window of the transmit antenna (414, 614) to the impedance window of the driver circuit (424, 624) so that the variable AC load 700 can be used to simulate the presence of a power receiving unit in the vicinity of the transmit antenna (414, 614). The location and positioning of a power receiving unit in the vicinity of the transmit antenna (414, 614) may vary, thus causing variations in the resistance and inductive reactance experienced by the transmit antenna (414, 614). The variable AC load 700 can simulate these impedance variations for purposes of testing the transmit circuitry 406 (FIG. 4) in response to the impedance variations. Although illustrated as separate elements, the adjustable resistance 702 and the adjustable inductive reactance (X) 704 are interrelated such that adjusting one at least partially affects the other. For example, adjusting the adjustable resistance 702 slightly affects the inductive reactance of the adjustable inductive reactance (X) 704. Similarly, adjusting the adjustable inductive reactance (X) 704 slightly affects the resistance of the adjustable resistance 702. The small amount of undesirable interaction between the resistance and the inductive reactance (X) can be compensated by slightly readjusting the adjustable resistance 702 if it is affected by the adjustment of the adjustable inductive reactance (X) 704; and by slightly readjusting the adjustable inductive reactance (X) 704 if it is affected by the adjustment of the adjustable resistance 702. For testing the transmit circuitry 406 (FIG. 4), the embodiments of the variable AC load 700 described herein may be electrically connected to the output of the transmit circuitry 406 in lieu of the transmit antenna 414 (e.g., via one or more coupling elements or terminals of the variable AC load 700).

FIG. 7B is a simplified schematic diagram illustrating an alternative embodiment of a variable AC load 710. The variable AC load 710 illustrates a differential implementation comprising adjustable resistances 712 and 722, adjustable inductive reactances (X) 714 and 724, and capacitances 707 and 716. The capacitances 707 and 716 represent the characteristic capacitance of the variable AC load 710, and are not necessarily adjustable. The capacitances 707 and 716 may be discrete elements that are part of the variable AC load 710, or the capacitances 707 and 716 may be separate elements. Although illustrated as separate elements, the adjustable inductive reactance (X) 714 and the adjustable inductive reactance (X) 724 may comprise a single center-tapped inductance 718 characterized by a center-tap node 708.

In an exemplary embodiment, the operational range of the variable AC load 710 encompasses the impedance range of the transmit antenna (414, 614) (or presented by the transmit antenna (414, 614)) that operates with the driver circuit (424, 624) in the transmit circuitry 406 (FIG. 4). Adjusting the resistance and the inductive reactance (i.e., reactance shifting) of the variable AC load 710 maps the impedance window of the transmit antenna (414, 614) to the impedance window of the driver circuit (424, 624) so that the variable AC load 710 can be used to simulate the presence of a power receiving unit in the vicinity of the transmit antenna (414, 614), as described with respect to FIG. 7A. Although illustrated as separate elements, the adjustable resistances 712 and 722; and the adjustable inductive reactances (X) 714 and 724 are interrelated such that adjusting one at least partially affects the other. For example, adjusting the adjustable resistance 712 slightly affects the inductive reactance of the adjustable inductive reactance (X) 714; and adjusting the adjustable resistance 722 slightly affects the inductive reactance of the adjustable inductive reactance (X) 724. Similarly, adjusting the adjustable inductive reactance (X) 714 slightly affects the resistance of the adjustable resistance 712 and adjusting the adjustable inductive reactance (X) 724 slightly affects the resistance of the adjustable resistance 722. The small amount of undesirable interaction between the resistance and the inductive reactance (X) can be compensated by slightly readjusting the adjustable resistance 712 if it is affected by the adjustment of the adjustable inductive reactance (X) 714; and by slightly readjusting the adjustable inductive reactance (X) 714 if it is affected by the adjustment of the adjustable resistance 712; and by slightly readjusting the adjustable resistance 722 if it is affected by the adjustment of the adjustable inductive reactance (X) 724; and by slightly readjusting the adjustable inductive reactance (X) 724 if it is affected by the adjustment of the adjustable resistance 722. In the embodiment shown in FIG. 7B, it is desirable to adjust the adjustable resistances 712 and 722 together to have the same value, and to adjust the adjustable inductive reactances 714 and 724 together so they have the same value, so that the center-tap node 708 remains a balanced center tap.

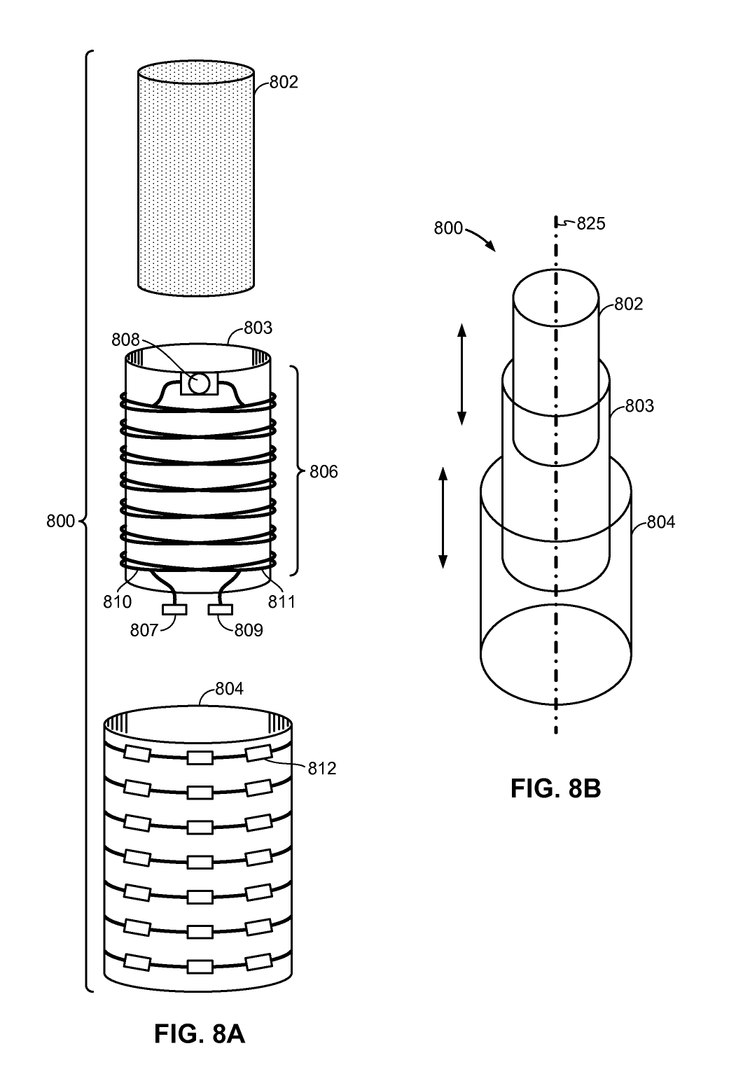

FIG. 8A shows an exemplary embodiment of three elements that comprise a variable AC load 800. In an exemplary embodiment, the variable AC load 800 comprises an implementation of the variable AC load of FIG. 7B. In an exemplary embodiment, the three elements comprise a conductive element 802 (also referred to as a highly conductive plug), an inductive element 803 and a resistive element 804 (also referred to as a low conductive sleeve).

The conductive element 802 can be formed using for example, copper, silver, metal alloy, or any other highly conductive material. In an exemplary embodiment, the conductive material may comprise a solid conductive structure, or can comprise a sheet of conductive material wrapped around a structural element. The conductive element 802 may also comprise one or more series capacitors (not shown) to at least partially diminish or cancel leakage inductance.

In an exemplary differential embodiment, the inductive element 803 can comprise a differentially wound structure comprising windings 806, connectors 807 and 809 (e.g., coupling elements), and center tap connector 808. As used herein, the term “differentially wound” refers to a coil that comprises two windings, or two winding portions 810 and 811, each having a connector 807 and 809 configured to connect to a differential output source. For example, in an embodiment, the driver circuit 424 (FIG. 4) may comprise differential outputs that are coupled to the connectors 807 and 809. Further, the inductive element 803 comprises a center-tapped structure where a connector 808 is located substantially in the center of the length of the windings 806. However, the inductive element 803 may comprise other structures, and in particular, structures other than center-tapped. In an alternative implementation, the center tap connector 808 of the inductive element 803 may not be used, or the inductive element 803 may not be center-tapped. In a non center-tapped implementation, or a single-ended implementation, the center tap connector 808 is not connected, the connector 807 may be connected to a single-ended power amplifier, and the connector 809 may be connected to ground.

The resistive element 804 comprises resistances 812 arranged to provide a low conductive structure. As used herein, the terms “resistive” and “low conductive” to describe the resistive element 804 are intended to be relative with respect to the conductive element 802, whereby the resistive element 804 is less conductive than the conductive element 802. The resistive element 804 may be fabricated using a length of wire looped around a structure with resistors inserted along the length of wire to achieve the desired conductivity. The resistive element 804 may also comprise one or more series capacitors (not shown) to at least partially diminish or cancel leakage inductance.

The positions of the conductive element 802, the inductive element 803 and the resistive element 804 may differ from that shown. For example, the positions of the conductive element 802 and the resistive element 804 may be reversed.

FIG. 8B shows an exemplary embodiment of a variable AC load 800 comprising the three elements of FIG. 8A. In an exemplary embodiment, the conductive element 802, the inductive element 803, and the resistive element 804 are coaxially aligned, cylindrically shaped elements. As used herein, the term “coaxially aligned” refers to the conductive element 802, the inductive element 803, and the resistive element 804 sharing an axis 825 and being located one inside the other. For example, in an exemplary embodiment, the conductive element 802 is configured to fit within the inductive element 803 and move relative to the inductive element 803 along the axis 825. Similarly, in an exemplary embodiment, the inductive element 803 is configured to fit within the resistive element 804 and move relative to the resistive element 804 along the axis 825. Any of the conductive element 802, the inductive element 803, and the resistive element 804 can be moveable or stationary, so long as relative movement, orientation and location between the conductive element 802 and the inductive element 803 can be achieved; and so long as relative movement, orientation and location between the inductive element 803 and the resistive element 804 can be achieved. In exemplary embodiments, the relative movement of the conductive element 802, the inductive element 803 and the resistive element 804 can be achieved by manually moving the elements, or by employing a mechanical system that may use motors, gearing, or other systems to achieve the relative movement, orientation, location and positioning.

In an exemplary embodiment, the relative axial position of the conductive element 802, the inductive element 803, and the resistive element 804 provides continually adjustable resistance and continually adjustable inductive reactance of the variable AC load 800. In exemplary embodiments, the relative movement of the conductive element 802, the inductive element 803 and the resistive element 804 can be achieved by manually moving the elements, or by employing a mechanical system that may use motors, gearing, or other systems to achieve the relative movement, orientation and positioning. The variable AC load 800 creates continuously variable resistance and inductive reactance for testing a wireless power transmitter. Both the resistance and the inductive reactance of the variable AC load 800 can be independently adjusted and/or simultaneously adjusted to simulate the impedance of a resonator.

Reactance is measured in ohms but is given the symbol “X” to distinguish it from a purely resistive “R” value. The adjustable component of reactance is an inductor, which can be embodied by any of the adjustable inductive reactances (X) 704, 714, 724 described herein. The reactance of an inductor is referred to as inductive reactance, (X_{L}), and is measured in ohms. The “j” denotes that the inductive reactance is imaginary. The inductive reactance, (X_{L}) is defined by the formula:

X_{L}=j2πfL Eq. 1

where X_{L} is the inductive reactance in ohms, f is the frequency in Hertz and L is the inductance of the coil in henries.

As used herein, the term “variable AC load” refers to the ability to individually and simultaneously adjust the resistance and the inductive reactance of the variable AC load 800. In an embodiment, the variable AC load 800 can use an air core inductor as the inductive element 803, a copper tube as the conductive element 802, and a resistive sleeve as the resistive element 804, arranged as shown in FIG. 8B that when adjusted relative to each other, can vary the resistance and the inductive reactance of the variable AC load 800. The resistance and the inductance of the air inductor are varied by moving the copper tube and the resistive sleeve relative to each other and relative to the air inductor.

In an exemplary embodiment, the variable AC load 800 provides a resistance on the order of one (1) ohm (Ω) or lower, and a high reactance on the order of 400 jΩ or higher. As mentioned above, because inductive reactance is imaginary, the quantity is expressed as “jΩ.” For example, the complex impedance could be stated as 10+400j to indicate 10 real (resistive ohms) and 400 imaginary (reactive) ohms

In an exemplary embodiment, the conductive element 802, and the relative position of the conductive element 802 with respect to the inductive element 803 affects the inductive reactance of the variable AC load 800. In an exemplary embodiment, the resistive element 804, and the relative position of the resistive element 804 with respect to the inductive element 803 affects the resistance of the variable AC load 800. However, the variability of the resistance and the inductive reactance are not completely independent in that varying the inductive reactance with the conductive element 802 also at least slightly affects the resistance of the variable AC load 800; and varying the resistance with the resistive element 804 also at least slightly affects the inductive reactance of the variable AC load 800. The variable AC load 800 does not create any capacitance in addition to the characteristic capacitance mentioned in FIGS. 7A and 7B.

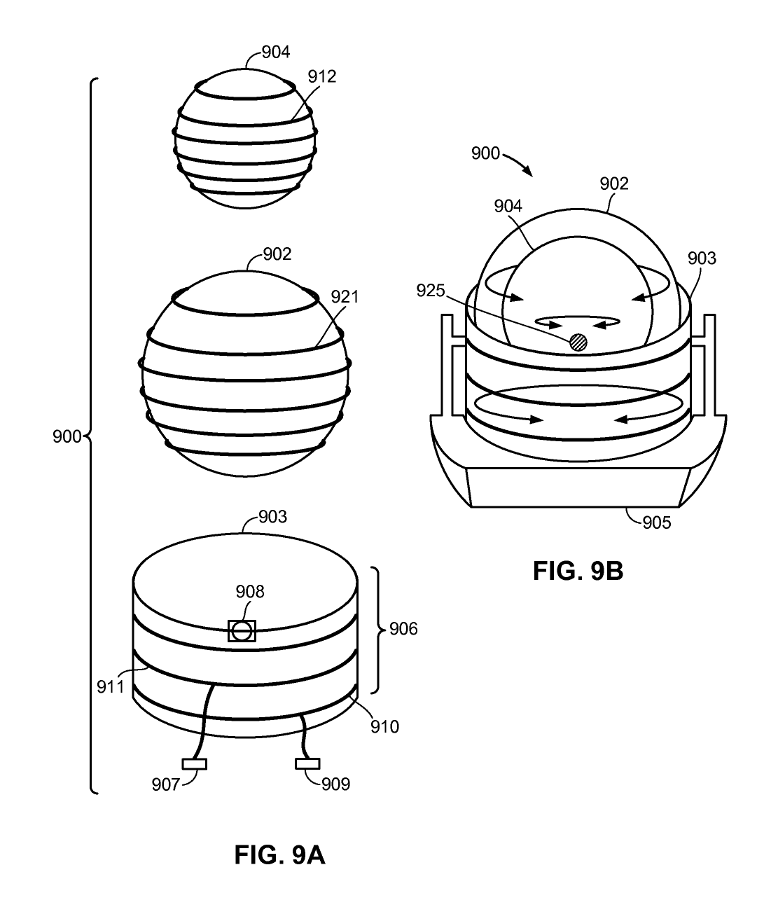

FIG. 9A shows an alternative exemplary embodiment of three elements that comprise a variable AC load 900. The variable AC load 900 operates in a similar manner as the variable AC load 800 of FIGS. 8A and 8B, but, in an exemplary embodiment, comprises a circular form factor in which the elements can be cylindrical, or spherical in shape. In an exemplary embodiment, the three elements comprise a conductive element 902, an inductive element 903 and a resistive element 904 (also referred to as a low conductive element).

The conductive element 902 can be formed using a plastic, phenolic, or other material and can be wound or otherwise provided with conductive material 921. As an example only, the conductive material 921 can be copper wire, silver wire, other metallic elements, or any other conductive material. The conductive element 902 may also comprise one or more series capacitors (not shown) to at least partially diminish or cancel leakage inductance.

The inductive element 903 can comprise a differentially wound structure comprising windings 906, connectors 907 and 909, and center tap connector 908. As used herein, the term “differentially wound” refers to a coil that comprises two windings, or two winding portions 910 and 911, each having a connector 907 and 909, respectively, configured to connect to a differential output source. For example, in an embodiment, the driver circuit 424 (FIG. 4) may comprise differential outputs that are coupled to the connectors 907 and 909. Further, the inductive element 903 comprises a center-tapped structure where a connector 908 is located substantially in the center of the length of the windings 906. However, the inductive element 903 may comprise other structures, and in particular, structures other than center-tapped, as described above with respect to the inductive element 803 of FIG. 8A.

The resistive element 904 comprises resistive material 912 arranged to provide a low conductive structure. As used herein, the terms “resistive” and “low conductive” to describe the resistive element 904 are intended to be relative with respect to the conductive element 902, whereby the resistive element 904 is less conductive than the conductive element 902. The resistive element 904 may also comprise one or more series capacitors (not shown) to at least partially diminish or cancel leakage inductance.

FIG. 9B shows an exemplary embodiment of a variable AC load 900 comprising the three elements of FIG. 9A. In an exemplary embodiment, the conductive element 902, the inductive element 903, and the resistive element 904 are generally circular in shape and located relative to each other by a support structure 905 such that relative rotational motion about a single point 925 is possible between and among the conductive element 902, the inductive element 903, and the resistive element 904. In an exemplary embodiment, the conductive element 902, the inductive element 903, and the resistive element 904 are concentrically related, generally circularly shaped elements that can be cylindrically or spherically shaped. As used herein, the term “concentrically related” refers to the conductive element 902, the inductive element 903, and the resistive element 904 sharing a common central point 925 and located one inside the other. For example, in an exemplary embodiment, the resistive element 904 is configured to fit within the conductive element 902 and move relative to the inductive element 903 and the conductive element 902 about the point 925. Similarly, in an exemplary embodiment, the conductive element 902 is configured to fit within the inductive element 903 and move relative to the resistive element 904 and the inductive element 903 about the point 925. Any of the conductive element 902, the inductive element 903, and the resistive element 904 can be moveable or stationary, so long as relative movement, orientation and location between the conductive element 902 and the inductive element 903 can be achieved; and so long as relative movement, orientation and location between the inductive element 903 and the resistive element 904 can be achieved. The relative rotational position or orientation of the conductive element 902, the inductive element 903, and the resistive element 904 provides continually adjustable resistance and continually adjustable inductive reactance of the variable AC load 900. In exemplary embodiments, the relative movement of the conductive element 902, the inductive element 903 and the resistive element 904 can be achieved by manually moving the elements, or by employing a mechanical system that may use motors, gearing, or other systems to achieve the relative movement, orientation and positioning.

In an exemplary embodiment, the variable AC load 900 creates continuously variable resistance and inductive reactance for testing a wireless power transmitter. Both the resistance and the inductive reactance of the variable AC load 900 can be independently adjusted and/or simultaneously adjusted to simulate the impedance of a resonator, as described above with respect to FIGS. 8A and 8B.

In an exemplary embodiment, the variable AC load 900 can comprise a cylinder, or a substantially cylindrically shaped element, having a wound inductor as the inductive element 903, a sphere, or a substantially spherically shaped element, having conductive material wrapped thereon as the conductive element 902, and a sphere, or a substantially spherically shaped element, having resistive material wrapped thereon as the resistive element 904, arranged one inside the other as shown in FIG. 9B. The conductive element 902, inductive element 903 and the resistive element 904 can be supported by the support structure 905 such that when rotationally adjusted relative to each other about the point 925, provide variable resistance and inductive reactance of the variable AC load 900. The resistance and the inductance of the inductive element 903 are varied by moving the conductive element 902 and the resistive element 904 relative to each other and relative to the inductive element 903. In an exemplary embodiment, the variable AC load 900 provides a resistance on the order of one (1) ohm (Ω) or lower, and a high reactance on the order of 400 jΩ or higher.

In an exemplary embodiment, the conductive element 902, and the relative position of the conductive element 902 with respect to the inductive element 903 affects the inductive reactance of the variable AC load 900. In an exemplary embodiment, the resistive element 904, and the relative position of the resistive element 904 with respect to the inductive element 903 affects the resistance of the variable AC load 900. However, the variability of the resistance and the inductive reactance are not completely independent in that varying the inductive reactance with the conductive element 902 also at least slightly affects the resistance of the variable AC load 900; and varying the resistance with the resistive element 904 also at least slightly affects the inductive reactance of the variable AC load 900. The variable AC load 900 does not create any capacitance in addition to the characteristic capacitance mentioned in FIGS. 7A and 7B.

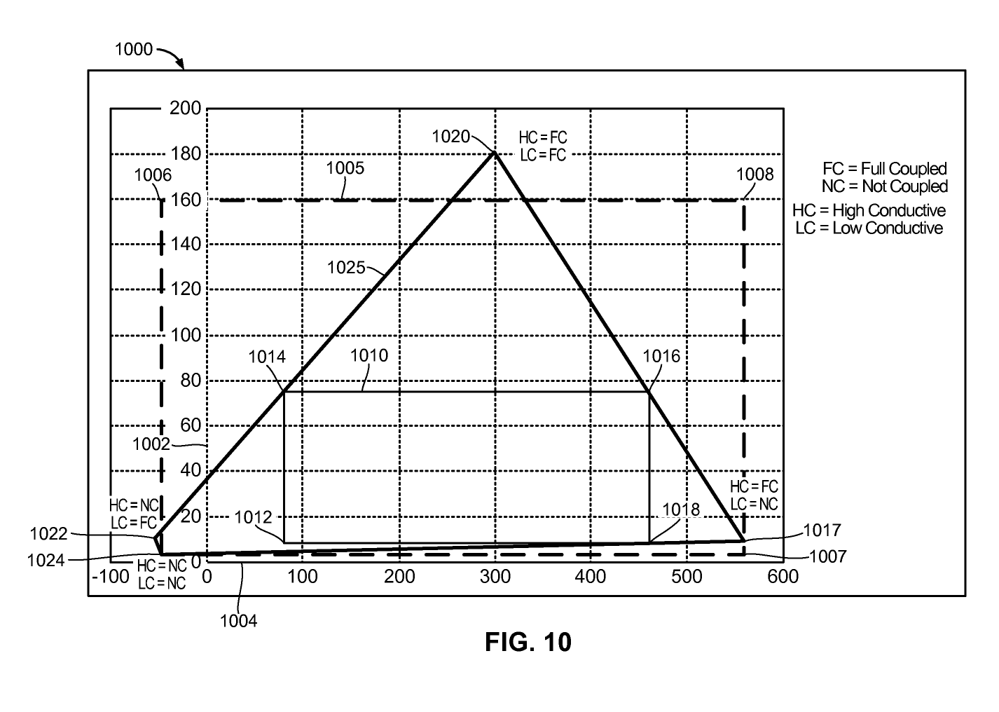

FIG. 10 shows a graphical depiction 1000 of the operational ranges of the resistance and inductive reactance of the variable AC load 800 of FIGS. 8A and 8B and the variable AC load 900 of FIGS. 9A and 9B. The description of FIG. 10 will refer to the elements of the variable AC load 800, but are equally applicable to the elements of the variable AC load 900. The vertical axis 1002 refers to resistance (in ohms) and the horizontal axis 1004 refers to inductive reactance (X) (in j ohms)

The dotted box 1005 depicts an exemplary rectangular window showing ideal maximum adjustability of resistance and inductive reactance for an exemplary embodiment, and describes an ideal situation in which adjusting the resistance does not affect the inductive reactance and adjusting the inductive reactance does not affect the resistance. However, in practice adjusting the resistance affects the inductive reactance and adjusting the inductive reactance affects the resistance, resulting in the point 1006 relocating to the point 1022, the point 1008 relocating to the point 1020 and the point 1007 relocating to the point 1017. In practice, this interaction between the resistance and the inductive reactance causes the ideal dotted box 1005 to approximate a triangle 1025.

With respect to FIG. 10, the term “HC” refers to the conductive element 802 and the term “LC” refers to the resistive element 804. The term “NC” refers to no electrical coupling between the respective elements and the term “FC” refers to full electrical coupling between the respective elements.

At the point 1020, the conductive element 802 (HC) is fully coupled (FC) to the inductive element 803 and the resistive element 804 (LC) is fully coupled (FC) to the inductive element 803.

At the point 1017, the conductive element 802 (HC) is fully coupled (FC) to the inductive element 803 and the resistive element 804 (LC) is not coupled (NC) to the inductive element 803.

At the point 1022, the conductive element 802 (HC) is not coupled (NC) to the inductive element 803 and the resistive element 804 (LC) is fully coupled (FC) to the inductive element 803.

At the point 1024, the conductive element 802 (HC) is not coupled (NC) to the inductive element 803 and the resistive element 804 (LC) is not coupled (NC) to the inductive element 803.

The region 1010 refers to values of resistance and inductive reactance created by the variable AC load 800 that represent operational and functional values of resistance and inductive reactance for an illustrative exemplary embodiment. The driver circuit 424 (FIG. 4) should be able to provide current through the transmit antenna 414 (FIG. 4) that satisfies a resonator current threshold value across a specified range of impedance (Z_{TX}_{_}_{IN}), where

R_{TX}_{_}_{IN}_{_}_{MIN}≦Re{Z_{TX}_{_}_{IN}}≦R_{TX}_{_}_{IN}_{_}_{MAX}

X_{TX}_{_}_{IN}_{_}_{MIN}≦Im{Z_{TX}_{_}_{IN}}≦X_{TX}_{_}_{IN}_{_}_{MAX}.

The variable AC load 800 should have the ability to simulate the presence of one or more power receiving units while allowing the driver circuit 424 (FIG. 4) to remain within its operational window.

For example, the point 1012 corresponds to a point where the variable AC load 800 provides a minimum operational resistance of R_{TX}_{_}_{IN}_{_}_{MIN} and a minimum operational inductive reactance of X_{TX}_{_}_{IN}_{_}_{MIN}.

The point 1014 corresponds to a point where the variable AC load 800 provides a maximum operational resistance of R_{TX}_{_}_{IN}_{_}_{MAX} and a minimum operational inductive reactance of X_{TX}_{_}_{IN}_{_}_{MIN}.

The point 1016 corresponds to a point where the variable AC load 800 provides a maximum operational resistance of R_{TX}_{_}_{IN}_{_}_{MAX} and a maximum operational inductive reactance of X_{TX}_{_}_{IN}_{_}_{MAX}.

The point 1018 corresponds to a point where the variable AC load 800 provides a minimum operational resistance of R_{TX}_{_}_{IN}_{_}_{MIN} and a maximum operational inductive reactance of X_{TX}_{_}_{IN}_{_}_{MAX}.

In an exemplary embodiment, the variable AC load 800 can provide a resistance range between 8.1 ohms (R_{TX}_{_}_{IN}_{_}_{MIN}) and 75 ohms (R_{TX}_{_}_{IN}_{_}_{MAX}), and can provide an inductive reactance (X) range between 80.3 ohms (X_{TX}_{_}_{IN}_{_}_{MIN}) and 460.2 ohms (X_{TX}_{_}_{IN}_{_}_{MAX}), placing the resistance and inductive reactance of the variable AC load at any point within the box 1010.

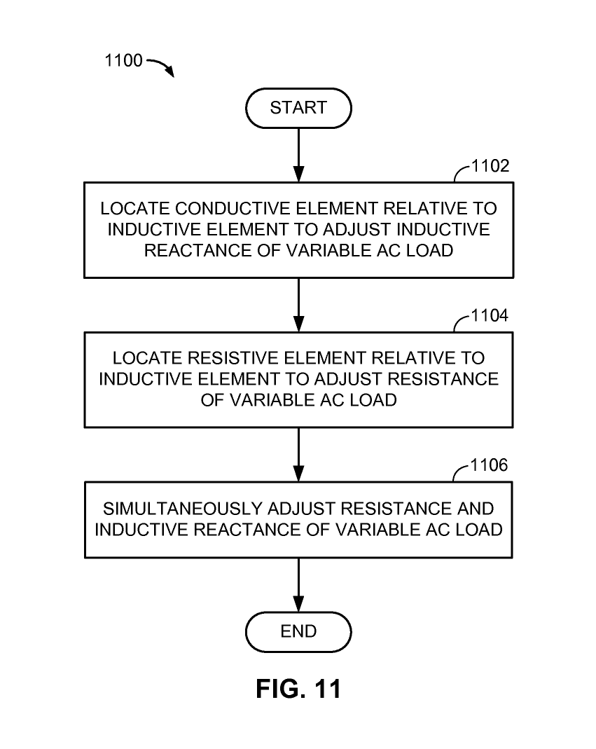

FIG. 11 is a flowchart illustrating an exemplary embodiment of a method 1100 for varying an AC load. The blocks in the method 1100 can be performed in or out of the order shown. The description of the method 1100 will relate to the embodiment of the variable AC load 800 shown in FIGS. 8A and 8B for convenience of description only. The method 1100 applies to the variable AC load 900 of FIGS. 9A and 9B as well.

In block 1102, the conductive element 802 is located relative to the inductive element 803 to adjust the inductive reactance of the variable AC load 800.

In block 1104, the resistive element 804 is located relative to the inductive element 803 to adjust the resistance of the variable AC load 800.

In block 1106, the resistance and the inductive reactance of the variable AC load are simultaneously adjusted. In an exemplary embodiment, the location of the conductive element 802 relative to the inductive element 803 and the location of the resistive element 804 relative to the inductive element 803 are simultaneously adjusted so that the resistance and the inductive reactance of the variable AC load 800 can be simultaneously adjusted.

Although shown in FIGS. 8A and 8B as cylindrical and in FIGS. 9A and 9B as cylindrical and spherical, the three elements that comprise the variable AC load can take other forms, or other shapes. Further, any of the conductive element, the inductive element, and the resistive element can be stationary while the other two of the conductive element, the inductive element, and the resistive element can be moveable.

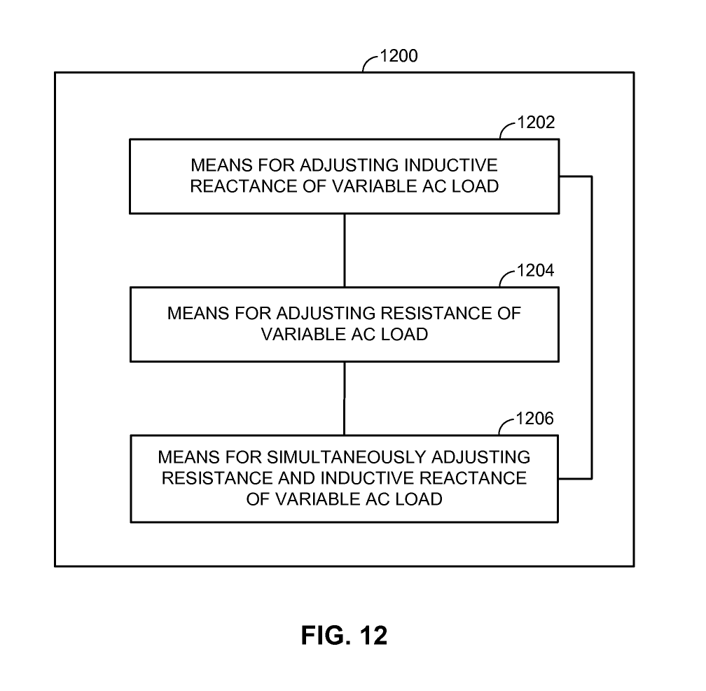

FIG. 12 is a functional block diagram of an apparatus 1200 for varying an AC load. The apparatus 1200 comprises means 1202 for adjusting the inductive reactance of the variable AC load 800. In certain embodiments, the means 1202 for adjusting the inductive reactance of the variable AC load 800 can be configured to perform one or more of the function described in operation block 1102 of method 1100 (FIG. 11). In an exemplary embodiment, the means 1202 for adjusting the inductive reactance of the variable AC load 800 may comprise the conductive element 802, and the relative position of the conductive element 802 with respect to the inductive element 803. The apparatus 1200 further comprises means 1204 for adjusting the resistance of the variable AC load 800. In certain embodiments, the means 1204 for adjusting the resistance of the variable AC load 800 can be configured to perform one or more of the function described in operation block 1104 of method 1100 (FIG. 11). In an exemplary embodiment, the means 1204 for adjusting the resistance of the variable AC load 800 may comprise the resistive element 804, and the relative position of the resistive element 804 with respect to the inductive element 803. The apparatus 1200 further comprises means 1206 for simultaneously adjusting the resistance and the inductive reactance of the variable AC load 800. In certain embodiments, the means 1206 for simultaneously adjusting the resistance and the inductive reactance of the variable AC load 800 can be configured to perform one or more of the function described in operation block 1106 of method 1100 (FIG. 11). In an exemplary embodiment, the means 1206 for simultaneously adjusting the resistance and the inductive reactance of the variable AC load 800 may comprise the simultaneous adjustment of the relative position of the conductive element 802 with respect to the inductive element 803; and the simultaneous adjustment of the relative position of the resistive element 804 with respect to the inductive element 803.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Advantages include, but are not limited to continuous adjustability of resistance and inductive reactance, leading to continuous resolution, limited transients between setpoints, and a scalable design.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

1. A variable AC load comprising:
a conductive element;
an inductive element; and
a resistive element, wherein a relative position of the conductive element with respect to the inductive element, and a relative position of the resistive element with respect to the inductive element, provides continually and simultaneously adjustable inductive reactance and resistance.

2. The variable AC load of claim 1, wherein the relative position of the conductive element and the inductive element adjusts the inductive reactance of the variable AC load.

3. The variable AC load of claim 1, wherein the relative position of the resistive element and the inductive element adjusts the resistance of the variable AC load.

4. The variable AC load of claim 1, wherein the conductive element, the inductive element and the resistive element comprise coaxially aligned cylindrically shaped elements.

5. The variable AC load of claim 1, wherein the conductive element, the inductive element and the resistive element comprise concentrically related circularly shaped elements.

6. The variable AC load of claim 1, wherein the inductive element comprises a single-ended structure.

7. The variable AC load of claim 1, wherein the inductive element comprises a differential structure.

8. The variable AC load of claim 7, wherein the differential structure comprises a center-tapped inductive element.

9. The variable AC load of claim 1, further comprising:
one or more coupling elements configured to electrically couple the variable AC load to transmit circuitry, the variable AC load being configured to present an adjustable resistance and an adjustable inductive reactance to the transmit circuitry.

10. The variable AC load of claim 1, further comprising:
a transmit antenna associated with transmit circuitry, the transmit antenna and the transmit circuitry comprising a wireless power transmitter, wherein a range of resistance adjustment and a range of inductive reactance adjustment of the variable AC load corresponds to a range of impedance presented to the transmit antenna by a plurality of wireless power receivers.

11. The variable AC load of claim 1, further comprising a support structure configured to manually adjust the relative position of the conductive element with respect to the inductive element and the relative position of the resistive element with respect to the inductive element.

12. The variable AC load of claim 1, further comprising a support structure having a motor configured to adjust the relative position of the conductive element with respect to the inductive element and the relative position of the resistive element with respect to the inductive element.

13. A variable AC load comprising a three element structure, wherein a relative position of a first element, a second element, and a third element is configured to provide continually adjustable inductive reactance and resistance.

14. The variable AC load of claim 13, wherein the first element comprises a conductive element, the second element comprises an inductive element and the third element comprises a resistive element.

15. The variable AC load of claim 14, wherein a relative position of the conductive element and the inductive element adjusts the inductive reactance of the variable AC load, and a relative position of the resistive element and the inductive element adjusts the resistance of the variable AC load.

16. The variable AC load of claim 15, wherein the conductive element, the inductive element and the resistive element comprise coaxially aligned cylindrically shaped elements.

17. The variable AC load of claim 15, wherein the conductive element, the inductive element and the resistive element comprise concentrically related spherically shaped elements.

18. The variable AC load of claim 15, wherein the inductive element comprises a single-ended structure.

19. The variable AC load of claim 15, wherein the inductive element comprises a differential structure.

20. The variable AC load of claim 19, wherein the differential structure comprises a center-tapped inductive element.

21. The variable AC load of claim 13, further comprising:
transmit circuitry coupled to the variable AC load, the variable AC load being configured to present an adjustable resistance and an adjustable inductive reactance to the transmit circuitry.

22. The variable AC load of claim 21, further comprising:
a transmit antenna associated with the transmit circuitry, the transmit antenna and the transmit circuitry comprising a wireless power transmitter; and
a range of resistance adjustment and a range of inductive reactance adjustment of the variable AC load corresponds to a range of impedance presented to the transmit antenna by a plurality of wireless power receivers.

23. A device for generating a variable AC load, comprising:
means for adjusting an inductive reactance of the variable AC load;
means for adjusting a resistance of the variable AC load; and
means for simultaneously adjusting inductive reactance and resistance of the variable AC load.

24. The device of claim 23, wherein the means for adjusting the inductive reactance of the variable AC load further comprises means for adjusting a relative position of a conductive element and an inductive element.

25. The device of claim 23, wherein the means for adjusting the resistance of the variable AC load further comprises means for adjusting a relative position of a resistive element and an inductive element.

26. A method for generating a variable AC load, comprising:
locating a conductive element relative to an inductive element to adjust an inductive reactance;
locating a resistive element relative to the inductive element to adjust a resistance; and
simultaneously adjusting the inductive reactance and the resistance.

27. The method of claim 26, wherein a relative position of the conductive element and the inductive element adjusts the inductive reactance of the variable AC load.

28. The method of claim 26, wherein the relative position of the resistive element and the inductive element adjusts the resistance of the variable AC load.

29. The method of claim 26, further comprising:
coupling the variable AC load to transmit circuitry; and
simultaneously adjusting the inductive reactance and the resistance presented to the transmit circuitry.

30. The method of claim 29, wherein coupling the variable AC load to transmit circuitry comprises coupling the variable AC load to transmit circuitry coupled to a transmit antenna, the transmit antenna and the transmit circuitry comprising a wireless power transmitter; and wherein the method further comprises corresponding a range of resistance adjustment and a range of inductive reactance adjustment of the variable AC load to a range of impedance presented to the transmit antenna by a plurality of wireless power receivers.
